(19) United States
(12) Patent Application Publication
(10) Pub. No.: US 2009/0196539 A1
(43) Pub. Date: Aug. 6, 2009

(54) WIDE-WIDTH GUIDE CARRIAGE

(76) Inventors: Carsten Pfeuffer, Roethlein (DE); Roland Hartmann, Grettstadt (DE); Andreas Schupies, Gochsheim (DE); Stefan Dorn, Arnstein (DE)

Correspondence Address: Striker, Striker & Stenby, 103 East Neck Road, Huntington, NY, 11743, US

(21) Appl. No.: 12/359,389

(22) Filed: Jan. 26, 2009

(30) Foreign Application Priority Data
Jan. 31, 2008 (DE) 102008006819.5

(51) Int. Cl. F16C 29/06

(52) U.S. Cl. 384/45

(57) ABSTRACT

A guide carriage for a linear roller bearing is supportable in a longitudinally-moveable manner using at least two rows of endlessly circulating rolling elements on a guide rail which extends in a longitudinal direction, and includes a U-shaped carrier body having a first leg and a second leg, a deflection assembly for the at least two rows of rolling elements located on at least one longitudinal end face of the carrier body and including a first deflection part which is assigned to the first leg and a second deflection part which is assigned to the second leg, the two deflection parts being connected to one another via a connecting body, at least one outer wall surface of a curved deflection channel for the rolling elements is provided in the first and second deflection parts, one first and one second deflection insert are provided in the first and second deflection parts, respectively, on each of which at least one inner wall surface of the curved deflection channel is provided, and the first and second deflection inserts are provided as a single piece on an insert part, so that the first and second deflection parts and the connecting body are held together by the insert part, at least transversely to the longitudinal direction.

### CROSS-REFERENCE TO RELATED APPLICATION

The invention described and claimed hereinbelow is also described in German Patent Application DE 10 2008 006 819.5 filed on Jan. 31, 2008. This German Patent Application, whose subject matter is incorporated here by reference, provides the basis for a claim of priority of invention under 35 U.S.C. 119(a)-(d).

### BACKGROUND OF THE INVENTION

The present invention relates to a guide carriage, and to a linear roller bearing including the guide carriage.

DE 43 30 772 A1 describes a linear roller bearing having a guide rail which extends in a longitudinal direction, on which a guide carriage is supported in a longitudinally moveable direction via four rows of endlessly circulating balls. The guide carriage includes a U-shaped carrier body composed of hardened steel, on each of the two longitudinal end surfaces of which a deflection assembly for the rolling elements is provided. According to FIG. 4 in DE 43 30 772 A1, a deflection assembly 13 includes two deflection parts 13 which are assigned to the legs of the carrier body, and it includes a connecting body 74 which connects the two deflection parts 13 to one another.

The curved deflection channels for the rolling elements are defined by outer wall surfaces on the deflection parts and by inner wall surfaces which are formed on separate deflection inserts 60. Deflection assemblies of this type are particularly advantageous when used with a guide carriage having a very wide width, since the separate connecting body may be designed with nearly any possible length, without the risk of warpage occurring when the deflection components are injection-molded. In particular, it may always be ensured that the deflection assembly has exactly the same U-shaped cross-section as the carrier body.

### SUMMARY OF THE INVENTION

It is therefore an object of the present invention to provide a guide carriage as well as a linear roller bearing which are further improvements of the existing devices of this type.

Accordingly, it is provided that the first and second deflection inserts are provided as a single piece on an insert part, so that the first and second deflection parts and the connecting body are held together by the insert part at least transversely to the longitudinal direction. It is thereby ensured that the assembly composed of the two deflection parts, the connecting body, and the insert part may be installed in the carrier body in the preassembled state, without the risk that they will detach from one another. The assembly time of the guide carriage is reduced as a result. In contrast, with the guide carriage described in DE 43 30 772 A1, there is a risk that the deflection assembly will come apart during assembly, since it is not held together until it is screwed together with the carrier body.

With regard for the interconnection according to the present invention, it is decisive that the convex deflection inserts which form the inner wall surfaces of the curved deflection channels are inserted in exact-fit, concave recesses in the two deflection parts, thereby ensuring that they are held there in an essentially play-free manner. Via the one-pieced connection of the deflection inserts, the first and second deflection parts are therefore connected to one another in a fixed manner, at least transversely to the longitudinal direction. The connecting body is held in its position by the first and second deflection parts, and the entire deflection assembly is thereby held together.

The insert part may include a plate section which connects the first and second deflection parts to one another, the plate section being located at least in sections between the connecting body and the longitudinal end surface of the carrier body. The plate section has particularly small dimensions in the longitudinal direction, thereby enabling the deflection assembly to be particularly compact in design. By clamping the plate section between the carrier body and the connecting body, it is nevertheless ensured that the former may not bend.

At least one rolling element guide extension may be provided on the first and second deflection parts. The rolling element guide extension extends into the carrier body, and the insert part encloses the two rolling element guide extensions in a “U” shape. As a result, the insert part holds the deflection assembly together even when the deflection inserts are pulled out of the assigned receiving recesses of the deflection parts in the longitudinal direction. In this case, the deflection parts and the insert part are still engaged, so the deflection assembly is held together. As soon as the deflection assembly is slid onto the carrier body, the insert parts are automatically moved back into the correct position, i.e. the deflection inserts are located in the assigned receiving recesses once more with an exact fit.

A central lubricant connection may be provided on the connecting body, at least one lubricant outlet being provided on the first and second deflection inserts, and at least one first lubricant groove being provided on the insert part, which connects the central lubricant connection to the lubricant outlets, the lubricant groove preferably being covered by the longitudinal end surface of the carrier body. The open lubricant groove may be manufactured easily when the insert part is injection-molded. The number of joining gaps in the lubricant channel wall that must be sealed off is minimized via the selected configuration. The remaining joining gaps may be closed particularly securely using the assembly force between the deflection assembly and the carrier body, the assembly force being oriented in the longitudinal direction. The channel is preferably covered by the end surface of the carrier body, since it is usually particularly flat in design and is therefore particularly well-suited for use as a sealing surface. It is particularly preferred when the insert part is composed of a resilient material such as TEEE (thermoplastic ether ester elastomer), since this further improves the sealing effect. The lubricant outlet is located on the insert parts, because the rolling elements to be lubricated move past there with minimal clearance.

A lateral lubricant connection may be provided on the first and second deflection parts, the lateral lubricant connection being connected to a second lubricant groove on the connecting body via a lubricant channel which is closed as one piece. The second lubricant groove is connected to the central lubricant connection, and the second lubricant groove is preferably covered by the plate section of the insert part. The purpose of the present embodiment is to ensure that all lubricating points are evenly supplied with lubricant, in particular oil or grease, regardless of which lubricant connection is selected by the user. For this purpose, all lubricant channels extend outward from the lubricant connections to one central point, namely the connection point between the central lubricant connection and the second lubricant groove. From there, the lubricant flows via the first lubricant groove to the lubricating points. The connection between the first and second lubricant grooves may be established via an opening in the lubricant plate at the central point described above. The lubricant channel which is closed as one piece has a channel cross section which is defined by a single component, i.e. it is closed completely by the particular component. The second lubricant groove, however, is located exclusively on the surface of the connecting body and must be closed by the insert part.

In the present embodiment, the same advantages result in terms of the seal integrity of the second lubricant groove as with the first lubricant groove. Due to the lubricant channels which are closed as one piece, and which are located in the region of the transition between the two deflection parts and the connecting body, the lubricant is prevented from escaping through the unavoidable joining gaps there between the aforementioned components. Since the closed lubricant channels are relatively short, they may be easily formed using a sliding piece in the particular injection-molding tools.

A coupling contour may be provided on the first and second deflection parts. An adapted counter-coupling structure is provided on the connecting body, and the closed lubricant channels extend within the coupling contour and the counter-coupling contour. As a result, the seal integrity of the closed lubricant channels is improved further, since the lubricant in the joining gap between the coupling contour and the counter-coupling contour must overcome several direction changes in order to leave the closed lubricant channel. In addition, the correct orientation of the two deflection parts and the connecting body is ensured via the coupling contour and the counter-coupling contour. The coupling contour may be, e.g. an extension having an essential square or rectangular cross section.

Particularly preferably, the coupling and counter-coupling contours have an elliptical cross section, since this shape makes it possible to attain a particularly tight connection and to ensure that the deflection parts and the connecting body are unable to rotate relative to one another. In the case of the square cross section described above, the square corners in particular—which do not occur in the elliptical shape—have proven to be leak-prone. A circular cross section may also be used in this case, of course, if the aforementioned orientation function is eliminated.

The closed lubricant channels may extend parallel to the longitudinal direction in the region of the connecting body, in sections, thereby making it possible to manufacture them in a particularly cost-effective manner. The connecting body is manufactured using an injection-molding tool, the opening direction of which corresponds to the longitudinal direction of the linear roller bearing. This opening direction is preferred, because the aim is to always select an opening direction in which the injection-molding tool has the shortest extension possible, thereby enabling the component to be easily removed from the mold. At the same time, the second lubricant groove may be formed without using a separate ram. Via the aforementioned orientation of the closed lubricant channel parallel to the longitudinal direction, it may be formed using a simple, rigid mandrel on the injection-molding tool. In this context, it is pointed out that the closed lubricant channel expediently must bridge a certain distance in the longitudinal direction, in order to compensate for the offset between the coupling contour and the counter-coupling contour and the second lubricant groove.

The connecting body may extend past the first and second deflection parts toward the insert part, in the longitudinal direction. It is thereby ensured that the first and/or second lubricant groove are/is sealed particularly well, since they are located mainly or exclusively within the longitudinal projection of the connecting body. Via the overhang it is ensured that the connecting body presses via its entire surface against the plate section of the insert part. The sealing effect may be enhanced further by providing fastening screws for the deflection assembly in the region of the connecting body.

A sheet metal wiper may be provided for the guide rail, which encloses the first and second deflection assembly in a “U” shape. The sheet metal wiper has the primary function of wiping large foreign objects off of the guide rail, thereby preventing them from entering the deflection assembly. The aim, in particular, is to prevent damage to the seals located in the deflection assembly. The sheet metal wiper which is composed of metal is not damaged by the foreign objects. Via its U-shaped enclosure, the sheet metal wiper also performs the task of holding the deflection parts and the connecting body together. This is important, in particular, when the guide carriage is exposed to strong vibrations and shaking during operation. In this case, the rigid sheet metal wiper performs a substantially better securing function that do the remaining fastening means on the deflection assembly. The preferred type of sheet metal to use is steel sheet, and most preferably stainless steel sheet.

At least one thread may be provided on the sheet metal wiper, it being located concentrically to one of the lubricant connections. Grease fittings or stoppers for the lubricant connections may be screwed into this thread. The aforementioned elements may be screwed into the sheet metal thread with substantially greater torque than they would in a thread located directly in the deflection parts or the connecting body which is made of plastic. Greater seal integrity of the threaded connection may be attained as a result.

An orientation means may be provided on at least one deflection part. At least one adapted counter-orienting means is provided on the assigned deflection insert. Due to the orienting and counter-orienting means, it is possible to attain a particularly low-play fit between the deflection part and the deflection insert. An orienting projection designed as a segment is preferably used as the orienting means, which engages in an adapted groove as the counter-orienting means, with a slight press fit. The reverse case is also feasible, of course. It is advantageous when the deflection inserts are composed of resilient material such as TEEE. Via this embodiment, a fixed seat of the deflection insert in the deflection part is attained, which requires force to separate. The interlocking according to the present invention is particularly good as a result.

### BRIEF DESCRIPTION OF THE DRAWINGS

FIG. 1 shows a perspective view of linear roller bearing according to the present invention;

FIG. 2 shows a cross section of the linear roller bearing in FIG. 1, in the region of the carrier body;

FIG. 3 shows an exploded view of a deflection assembly of the linear roller bearing in FIG. 1;

FIG. 4 shows a perspective view of the insert part from a side facing away from the carrier body;

FIG. 5 shows a perspective view of a deflection part from a side facing the insert part; and

FIG. 6 shows a perspective view of the connecting body from a side facing the insert part.

### DESCRIPTION OF THE PREFERRED EMBODIMENTS

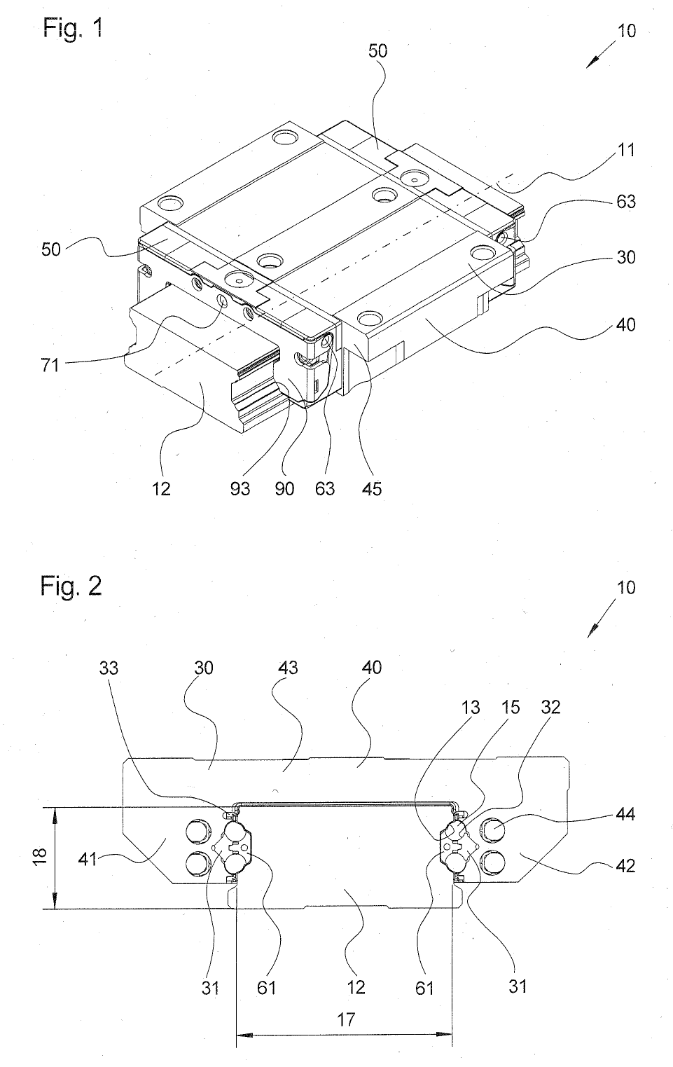

A linear roller bearing according to the present invention is labeled in general with reference numeral 10 in FIG. 1. It includes a guide rail 12 which extends in a longitudinal direction 11, and against which a guide carriage 30 is supported in a longitudinally moveable manner. Guide carriage 30 is composed of a carrier body 40, on longitudinal end surfaces 45 of which two identical deflection assemblies 50 for the endlessly circulating rolling elements are provided. A sheet metal wiper 90 is provided on each deflection assembly 50. Sheet metal wiper 90 has a wiping contour 93 which is designed to be essentially equidistant from guide rail 12, with slight clearance therefrom. Two lateral lubricant connections 63 and one central lubricant connection 71 are provided on the two sheet metal wipers 90. The aforementioned lubricant connections may be equipped with a grease fitting, for example. Any lubricant connections that are not needed are closed with a threaded pin.

FIG. 2 shows a cross section of linear roller bearing 10 in the region of carrier body 40. Carrier body 40 is essentially U-shaped in design and includes a first leg 41, a second leg 42, and a base 43. Two rows of endlessly circulating rolling elements 15 are provided on legs 41, 42. The load-bearing rolling elements roll between a rolling element track 13 on guide rail 12 and a rolling element track 32 on guide carriage 32. Two rolling element tracks 32 each are provided on a separate track insert 31 which is made of hardened rolling element steel, track insert 31 being supported on carrier body 40 which is composed of unhardened steel. A return channel 44 designed as a continuous bore is provided in carrier body 40 for each rolling element circuit. The endless circulatory channel for rolling elements 15 is completed by the curved deflection channels which will be described below in greater detail. Rolling element guide extensions 61 are also shown; they are used to hold the rolling elements in guide carriage 30 even when it is not located on guide rail 12. The rolling region is sealed off to the outside using longitudinal seals 33. Reference is also made to the dimensions of guide rail 12, width 17 of which is approximately twice as great as its height 18. As a result, linear roller bearing 10 has a greater load-carrying capacity with regard for the tilting load about the longitudinal axis. As addressed above, the design—according to the present invention—of the deflection assembly having the separate connecting body is based mainly to the relatively great width 17 of guide rail 12.

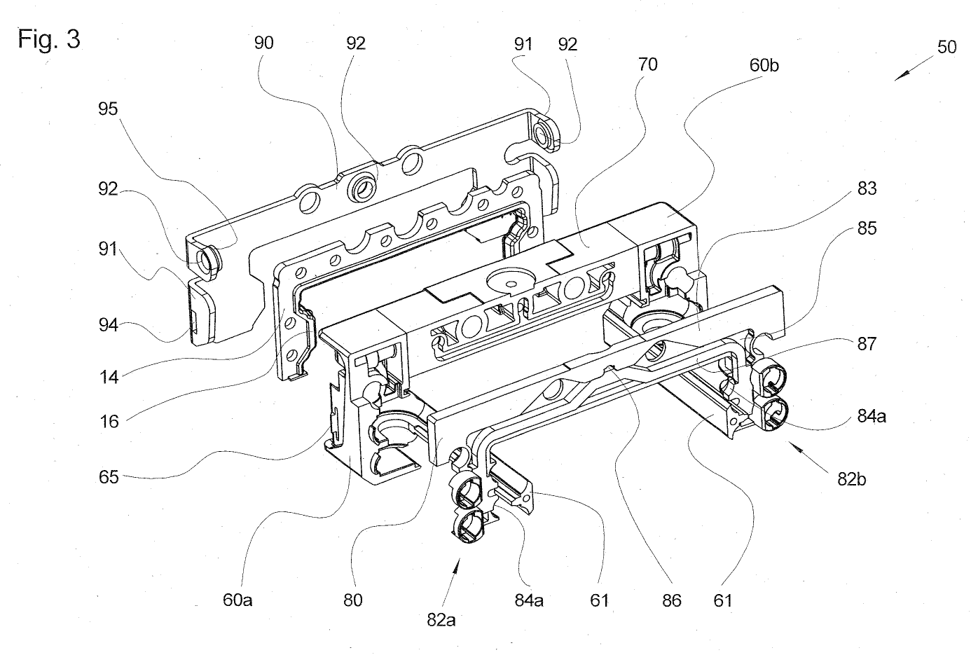

FIG. 3 shows an exploded view of a deflection assembly 50. Deflection assembly 50 includes a first deflection part 60a, a second deflection part 60b, and a one-pieced connecting body 70, all of which are shown in the interconnected state. A U-shaped insert part 80 is provided on the side of deflection assembly 50 facing the carrier body. U-shaped insert part 80 includes a first deflection insert 82a and a second deflection insert 82b, which are connected to one another via a plate section 83. Insert part 80 is tailored to deflection parts 60a, 60b and connecting body 70 in a manner such that deflection inserts 82a, 82b bear with slight preload from the outside against rolling element guide extensions 61 of deflection parts 60a, 60b, thereby holding the aforementioned components together.

First lubricant groove 85 in which a separate foam body 87 is inserted is also shown in FIG. 3. Foam body 87 is used to transport lubricating oil, thereby ensuring that it is delivered evenly from lubricant opening 86 to the four lubricant outlets 84a regardless of the installation position of the linear roller bearing. Lubricant outlets 84a are formed by the extensions on foam body 87 which are capable of touching the circulating rolling elements, thereby enabling lubricating oil to be transferred from foam body 87 to the rolling elements. Foam body 87 does not fill first lubricating groove 85 across the entire width, thereby enabling the remaining exposed cross section of first lubricating groove 85 to be used to deliver lubricating grease. Lubricating grease may be applied toward the rolling elements via a separate lubricant outlet which will be described in greater detail below. The contact surface of insert part 80 with the carrier body is designed completely flat. Insert part 80 is composed of the resilient material TEEE, thereby ensuring high seal integrity of the lubricant channel.

Deflection assembly 50 also includes an end seal 14 which bears via its sealing lip 16 against the guide rail and prevents lubricant from leaking out. End seal 14 is held on the guide carriage by sheet metal wiper 90. For this purpose, sheet metal wiper 90 is provided with a latching recess 94 on its legs 91. Latching recess 94 may engage with a snap-in projection 65 which is located on deflection parts 60a, 60b. In addition, three threads 92 which are situated coaxially to the lubricant connections described further below are provided on sheet metal wiper 90. To obtain a thread length of sufficient size, the sheet metal was provided with crimping 95 before the threads were cut.

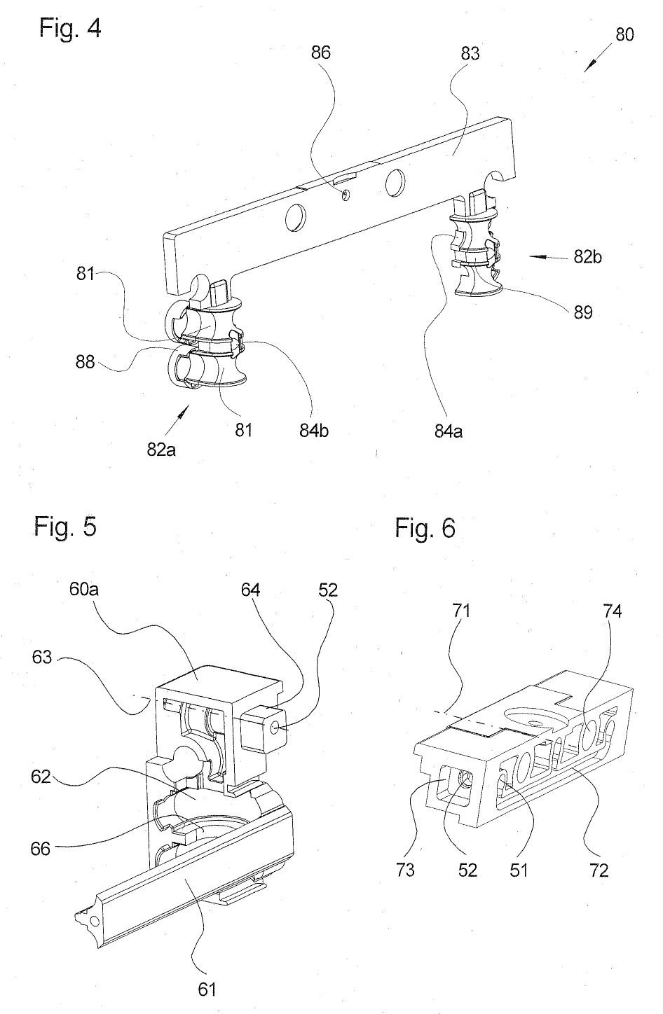

FIG. 4 shows insert part 80 from a side facing away from the carrier body. The illustration shows first and second deflection inserts 82a, 82b, on each of which two inner wall surfaces 81 of an assigned, curved deflection channel are provided. A lubricant outlet 84b for lubricating grease which extends past an opening connected with the first lubricant groove is provided between wall surfaces 81. Orienting grooves 89 are provided next to lubricant outlets 84b, and they engage in adapted orienting extensions on the first and second deflection parts, thereby ensuring that the components are held together according to the present invention. Resilient orienting grooves 89 are adapted to the orienting projections in a manner such that a press fit with a slight preload force is ensured.

FIG. 4 also shows how lubricant outlet 84a for lubricating oil extends into the curved deflection channel, thereby enabling it to touch the rolling elements that roll past. Plate section 83 which connects first and second deflection inserts 82a, 82b as a single piece to one another is designed completely flat on the side which is shown. Reference is made to central lubricant opening 86 which is connected to the first lubricant groove. The entire lubricant distribution system is designed such that the lubricant must always pass by lubricant opening 86 regardless of which lubricant connection it is delivered to or from which lubricant outlet it exits. As a result, an even distribution of the lubricant to all four rows of rolling elements is always ensured. The four centering rings 88 engage in adapted recesses in return bores in the carrier body, so that the deflecting insert is oriented exactly relative to the carrier body and the rolling element, and so that the travel of the rolling elements is not impaired by projections in the joining region of the aforementioned parts.

FIG. 5 shows first deflection part 60a from a side which faces the insert part. Second deflection part 60b is designed essentially as a mirror image of first deflection part 60a. The illustration shows the two outer walls 62 of the curved deflection channel, between which orientation extension 66 described above is located in the form of a segment which is curved parallel to the deflection channel. Outer wall surfaces 62 are continued on rolling element guide extension 61 without projections. Rolling element guide extension 61 extends over half the length of the carrier body, so it is continued from the adjacent rolling element guide extension of the opposite deflection part. Closed lubricant channel 52 is located inside square coupling contour 64, and it is situated somewhat off-center for reasons of space. A lateral lubricant connection 63 is provided as a straight extension of closed lubricant channel 52.

FIG. 6 shows the connecting body from a side facing the insert part. The illustration shows how closed lubricant channel 52 is continued as a straight line inside square counter-coupling contour 73. The coupling contour and counter-coupling contour are matched to each other in a manner such that an essentially lubricant-tight press fit is provided. Closed lubricant channel 52 also includes a section 51 which is parallel to the longitudinal direction and which leads into second lubricant groove 72 which is covered by the insert part. The lubricant opening described above (FIG. 4; number 86) also leads—as a straight-line extension of central lubricant connection 71—into second lubricant groove 72. Second lubricant groove 72 is situated in a manner such that it does not intersect openings 74 which are provided for fastening the deflection assembly to the carrier body using screw bolts.

It will be understood that each of the elements described above, or two or more together, may also find a useful application in other types of constructions differing from the types described above.

While the invention has been illustrated and described as embodied in a wide-width guide carriage, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A guide carriage for a linear roller bearing supportable in a longitudinally-moveable manner using at least two rows of endlessly circulating rolling elements on a guide rail extending in a longitudinal direction, the guide carriage comprising a U-shaped carrier body having a first leg and a second leg; a deflection assembly for the at least two rows of rolling elements located on at least one longitudinal end face of the carrier body and including a first deflection part assigned to the first leg and a second deflection part assigned to the second leg, with the two deflection parts being connected to one another via a connecting body; at least one outer wall surface of a curved deflection channel for the rolling elements provided in the first and second deflection parts; one first and one second deflection insert provided in the first and second deflection parts respectively, on each of which at least one inner wall surface of the curved deflection channel is provided, wherein the first and second deflection inserts are configured as a single piece on an insert part, so that the first and second deflection parts and the connecting body are held together by the insert part at least transversely to the longitudinal direction.

2. The guide carriage as defined in claim 1, wherein the insert part includes a plate section which connects the first and second deflection parts to one another, and is located at least in sections between the connecting body and a longitudinal end surface of the carrier body.

3. The guide carriage as defined in claim 1, further comprising at least one rolling element extension provided on the first and second deflection parts and extending into the carrier body while the insert part encloses the two rolling body extensions in a “U” shape.

4. The guide carriage as defined in claim 1, further comprising a central lubricant connection provided on the connecting body, at least one lubricant outlet provided on the first and second deflection inserts, and at least one first lubricant groove provided on the insert part and connecting the central lubricant connection to the lubricant outlets.

5. The guide carriage as defined in claim 4, wherein the lubricant groove is covered by a longitudinal end surface of the carrier body.

6. The guide carriage as defined in claim 4, further comprising a lateral lubricant connection provided on the first and second deflection parts and connected to a second lubricant groove on the connecting body via a lubricant channel which is closed as one piece, wherein the second lubricant groove is connected to the central lubricant connection.

7. The guide carriage as defined in claim 6, wherein the second lubricant groove is covered by a plate section of the insert part.

8. The guide carriage as defined in claim 1, further comprising a coupling contour provided on the first and second deflection parts, an adapted counter-coupling contour provided on the connecting body, and closed lubricant channels extending within the coupling contour and the counter-coupling contour.

9. The guide carriage as defined in claim 8, wherein the coupling contour and the counter-coupling contour have elliptical cross sections.

10. The guide carriage as defined in claim 1, further comprising closed lubricant channels extending parallel to the longitudinal direction in a region of the connecting body in sections.

11. The guide carriage as defined in claim 1, wherein the connecting body extends past the first deflection part and the second deflection part in the longitudinal direction toward the insert part.

12. The guide carriage as defined in claim 1, further comprising a sheet metal wiper for the guide rail, enclosing the first and second deflection assemblies in a “U” shape.

13. The guide carriage as defined in claim 12, further comprising at least one thread which is situated concentrically to one of lubricant connections and provided on the sheet metal wiper.

14. The guide carriage as defined in claim 1, further comprising orienting means provided on at least one deflection part, and at least one adapted counter-orienting means provided on an assigned deflection insert.

15. A linear roller bearing including a guide rail which extends in a longitudinal direction and on which a guide carriage defined in claim 1 is supported in a longitudinally movable manner via at least two rows of endlessly circulating rolling elements.

16. A linear roller bearing as defined in claim 15, wherein a ratio of width to height of the guide rail is at least 1.5.

17. A linear roller bearing as defined in claim 16, wherein the ratio of width to height of the guide rail is at least 2.
